(19) United States
(12) Patent Application Publication
(10) Pub. No.: US 2025/0130346 A1
(43) Pub. Date: Apr. 24, 2025

(54) SYSTEM AND METHOD FOR ESTIMATING RARE EARTH RESOURCES IN DEEP-SEA SEDIMENTS USING GAMMA RAYS

(71) Applicant: Korea Institute Of Geoscience And Mineral Resources, Daejeon (KR)

(72) Inventors: Changyoon LEE, Sejong-si (KR); Yuri KIM, Sejong-si (KR); Yoonmi KIM, Seoul (KR); Dowan KIM, Daejeon (KR); Seokhwi HONG, Daejeon (KR)

(73) Assignee: Korea Institute Of Geoscience And Mineral Resources, Daejeon (KR)

(21) Appl. No.: 18/909,456

(22) Filed: Oct. 8, 2024

(30) Foreign Application Priority Data
Oct. 24, 2023 (KR) 10-2023-0142658

(51) Int. Cl. G01V 5/06

(52) U.S. Cl. CPC G01V 5/06

(57) ABSTRACT

The purpose of the present disclosure is to provide a system and a method for identifying lithofacies classification information of rare earths in deep-sea sediments using the natural gamma ray data, as well as for estimating rare earth resource quantities in the deep-sea sediments. An aspect of the present disclosure provides a system for estimating rare earth resource quantities in deep-sea sediments using gamma rays, the system comprising: a data collecting unit configured to collect gamma ray data about deep-sea sediments; a data processing unit configured to normalize and process the gamma ray data collected by the data collecting unit; and an estimation modeling unit configured to generate a model for estimating a rare earth lithofacies classification information and the rare earth resource quantities using a linear regression based on the gamma ray data normalized by the data processing unit.

### CROSS-REFERENCE TO RELATED APPLICATION

This application claims priority to Korean Patent Application No. 10-2023-0142658 filed on Oct. 24, 2023, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a system and a method for classifying lithofacies or for estimating resource quantities. More particularly, the present disclosure relates to a system and a method for classifying rare earth lithofacies and for estimating rare earth resource quantities in deep-sea sediments through the modeling that analyzes relationships in gamma ray data.

### 2. Description of the Related Art

Rare earth elements (REEs) are mineral resources that are currently and widely used in high-tech industries, including IT-related products such as mobile phones and personal computers, ceramic products, capacitors, filters, sensors, rare earth permanent magnets, hydrogen-absorbing alloy batteries, automotive exhaust catalysts, glass abrasives, UV absorbers for automotive glass, and colorants for brown tube glass.

There are more than 200 minerals that contain rare earths, and some of the minerals that are currently commercially mined include Bastnaesite ((Ce,La)(CO₃)F), Monazite ((Ce,La,Nd,Th)PO₄), Xenotime (YPO₄), Fergusonite ((REE)(Nb,Ti)O₄), and ion-adsorbing clays.

Rare earths include 17 elements ranging from lanthanum (La, atomic number 57) to lutetium (Lu, atomic number 71), and may further include elements having similar chemical properties such as scandium (Sc, atomic number 21) and yttrium (Y, atomic number 31). Those rare earth elements are mainly used in high-tech industries and therefore are one of the most important raw materials for modern industry.

In the exploration of rare earth minerals, estimation and forecasting of rare earth resources or reserves deposited in ground or deep-sea is very important, and there is a need for technologies that can dramatically reduce time and cost for the exploration of rare earth minerals.

On the other hand, sedimentological interpretation using high-resolution gamma ray lithofacies data can be used to analyze the sedimentary environment and to interpret stratigraphy by contrasting with nearby boreholes, rather than simply classifying lithofacies (rock types).

These interpretations are typically performed using natural potential, gamma ray, resistivity, density, velocity, or neutron lithofacies values used for lithofacies or stratigraphic contrasts. In the case of gamma ray lithofacies, it is often used for sedimentary stratigraphic interpretation because the gamma ray lithofacies can predict changes in sediment grain size and sedimentary environment in view of changes in clay content.

In addition, the gamma ray lithofacies is a technique for measuring natural gamma rays (NGR) emitted naturally from sediments or rocks. These natural gamma ray emissions are caused by the decay of potassium (K), thorium (Th), and uranium (U). The geological significance of the gamma ray lithofacies depends on the distribution and abundance of these elements.

In general, the elements emitting gamma rays are found in most rocks. In particular, the elements emitting gamma rays are abundant in potassium feldspar and mica, which are the main products of weathering. Therefore, the elements emitting gamma rays are deposited with clay minerals and shale.

Consequently, shale formations have relatively high gamma ray lithofacies values, while sandstones and limestones that contain little clay minerals have relatively low gamma ray lithofacies values. In general, the change in the gamma ray lithofacies values are highly correlated with the change in clay content, although there are some intervals where the change in the gamma ray lithofacies value is influenced by highly radioactive materials (organic matter, heavy minerals, feldspar, rock fragments, etc.) independent of clay content.

For this reason, the gamma ray lithofacies is often referred to as an indicator of shale or clay content. In general, if the gamma-ray lithofacies value increases constantly from a small value to a large value, the content of clay is thought to be increasing. Conversely, if the gamma-ray lithofacies value constantly decreases from a small value to a constant large value, the content of clay is thought to be decreasing.

However, despite of the fact that information of minerals contained in the sediments can be estimated this natural gamma ray information, there is no technology available to effectively estimate and forecast the resource of rare earth minerals in deep-sea sediments.

### Related Patent Document

Patent Document 1: Korean Registered Patent No. 10-1982297 (Registration Date: May 20, 2019)

Patent Document 2: Korean Patent Publication No. 10-2020-0010897 (Publication Date: Jan. 31, 2020)

### SUMMARY OF THE DISCLOSURE

The purpose of the present disclosure, which aims to solve the aforementioned conventional problems, is to provide a system and a method for identifying lithofacies classification information of rare earths in deep-sea sediments using the natural gamma ray data, as well as for estimating rare earth resource quantities in the deep-sea sediments.

In addition, the purpose of the present disclosure is to provide a system and a method that can provide low-cost, fast, and effective identification of lithofacies classification of rare earths as well as estimation of rare earth resource quantities, when the system is integrated with systems where the natural gamma ray data is already collected or being collected.

In order to achieve the purpose, an aspect of the present disclosure provides a system for estimating rare earth resource quantities in deep-sea sediments using gamma rays, the system comprising: a data collecting unit configured to collect gamma ray data about deep-sea sediments; a data processing unit configured to normalize and process the gamma ray data collected by the data collecting unit; and an estimation modeling unit configured to generate a model for estimating rare earth lithofacies classification information and the rare earth resource quantities using a linear regression based on the gamma ray data normalized by the data processing unit.

In some exemplary embodiments, the gamma ray data may include natural gamma ray (NGR) data and sum of gamma ray (SGR) data.

In some exemplary embodiments, the data processing unit may include: a normalizing unit configured to normalize the gamma ray data collected by the data collecting unit; and a shale volume correcting unit configured to correct shale volume of the gamma ray data using X-ray diffraction (XRD) data.

In some exemplary embodiments, the estimation modeling unit may include: a lithofacies information unit configured to generate a rare earth lithofacies classification information to classify clay types by analyzing gamma ray spectrum data; and a linear regression modeling unit configured to generate a linear regression model by clay based on the rare earth lithofacies classification information and the gamma ray data normalized and corrected by the data processing unit.

In some exemplary embodiments, the rare earth lithofacies classification information may be generated by classifying the clay types based on rates of thorium (Th), potassium (K) and uranium (U) resulted from analysis of the gamma ray spectrum data.

In some exemplary embodiments, the system may further comprise a resource estimating unit configured to estimate and forecast a rare earth content by clay and a total rare earth resource quantity using a least square method according to the model generated by the estimation modeling unit.

In addition, in order to achieve the purpose, another aspect of the present disclosure provides a method for estimating rare earth resource quantities in deep-sea sediments using gamma rays, the method comprising the following steps of: (a) collecting, by a data collecting unit, gamma ray data about deep-sea sediments; (b) normalizing and processing, by a data processing unit, the gamma ray data collected by the data collecting unit; and (c) generating, by an estimation modeling unit, a model for estimating the rare earth resource quantities using a linear regression based on the gamma ray data normalized by the data processing unit.

In some exemplary embodiments, the step (a) may include a step of collecting, by the data collecting unit, natural gamma ray (NGR) data and sum of gamma ray (SGR) data about the deep-sea sediments.

In some exemplary embodiments, the step (b) may include the following steps of: (b1) normalizing, by the data processing unit, the gamma ray data collected by the data collecting unit; and (b2) correcting, by the data processing unit, shale volume of the gamma ray data using X-ray diffraction (XRD) data.

In some exemplary embodiments, the step (c) may include the following steps of: (c1) generating, by the estimation modeling unit, a rare earth lithofacies classification information to classify clay types by analyzing gamma ray spectrum data; and (c2) generating, by the estimation modeling unit, a linear regression model by clay based on the rare earth lithofacies classification information and the gamma ray data normalized and corrected by the data processing unit.

In some exemplary embodiments, the rare earth lithofacies classification information may be generated by classifying the clay types based on rates of thorium (Th), potassium (K) and uranium (U) resulted from analysis of the gamma ray spectrum data.

In some exemplary embodiments, the method may further comprise a step of estimating and forecasting, by a resource estimating unit, a rare earth content by clay and a total rare earth resource quantity using a least square method according to the model generated by the estimation modeling unit.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to some exemplary embodiments of the present disclosure, it can be provided a system and a method for identifying the rare earth lithofacies classification information of deep-sea sediments, as well as for estimating the rare earth resource quantities.

In addition, according to some exemplary embodiments of the present disclosure, as a non-invasive analysis and forecasting technique, it can be provided a system and a method for estimating the rare earth resource quantities without damaging or altering the sediment being analyzed, thereby preserving the natural state of the sediment.

In addition, according to some exemplary embodiments of the present disclosure, the acquisition of natural gamma ray (NGR) data may not require additional or specialized equipment as it is standard procedure in many deepwater drilling operations. Therefore, it can be provided a system and a method that can provide low-cost, fast, and effective identification of lithofacies classification of rare earths as well as estimation of rare earth resource quantities, when the system is integrated with systems where the natural gamma ray data is already collected or being collected.

In addition, according to some exemplary embodiments of the present disclosure, the use of NGR data in deepwater drilling makes available a vast amount of gamma-ray data, as well as allows for a broad preliminary assessment of rare earth potential.

In addition, according to some exemplary embodiments of the present disclosure, it can be provided a system and a method that can provide quick predictions for faster decision-making in exploration operations, as compared to the conventional methods that are labor intensive and time consuming for predicting and evaluating rare earth content.

In addition, according to some exemplary embodiments of the present disclosure, the gamma ray spectral data is useful for distinguishing various types of clays, such as bioapatite and Fe-Mn zeolite clays. Such specificity improves the accuracy of rare earth estimation and forecasting.

In addition, according to some exemplary embodiments of the present disclosure, it can be provided a system and a method that can improve forecasting accuracy for different sedimentary formations by incorporating multiple linear regression models tailored to different types of clays.

In addition, according to some exemplary embodiments of the present disclosure, presence of rare earths can be forecasted. Moreover, economic feasibility of the resource field may be measured, which can greatly assist in decision-making when considering exploration and potential extraction costs.

### BRIEF DESCRIPTION OF THE DRAWINGS

FIG. 1 is a block diagram illustrating a system for estimating rare earth resource quantities in deep-sea sediments using gamma rays according to an exemplary embodiment of the present disclosure.

FIG. 2 is a schematic diagram illustrating processes of a method for estimating rare earth resource quantities in deep-sea sediments using gamma rays according to an exemplary embodiment of the present disclosure.

FIG. 3 is a detailed flow diagram of a method for estimating rare earth resource quantities in deep-sea sediments using gamma rays according to an exemplary embodiment of the present disclosure.

FIG. 4 is a graph showing a result of comparison between rare earth measurements and shale volume (Vₛₕ) of natural gamma ray data for application of a method for estimating rare earth resource quantities in deep-sea sediments using gamma rays according to an exemplary embodiment of the present disclosure.

FIG. 5 is a distribution graph showing rare earth measurements in respect to shale volume (Vₛₕ) of natural gamma ray data for forecasting a rare earth lithofacies distribution based on gamma ray data according to a method for estimating rare earth resource quantities in deep-sea sediments using gamma rays according to an exemplary embodiment of the present disclosure.

FIGS. 6 through 8 are diagrams showing proportional relationships of bioapatite and Fe-Mn zeolite as well as Th, K lithofacies classification spectrum in uranium applied with a method for estimating rare earth resource quantities in deep-sea sediments using gamma rays according to an exemplary embodiment of the present disclosure.

FIG. 9 is a schematic diagram illustrating a relationship of bioapatite and Fe-Mn zeolite relative to uranium showing high rare earth content.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side”, “other side”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

One or more “unit” described in this specification can be implemented via a non-transitory memory (not shown) and a processor (not shown). The memory is configured to store data concerning algorithms designed to control the operation of system components according to exemplary embodiments of the present invention, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Hereinafter, exemplary embodiments of the present disclosure will be described in detail with reference to related drawings.

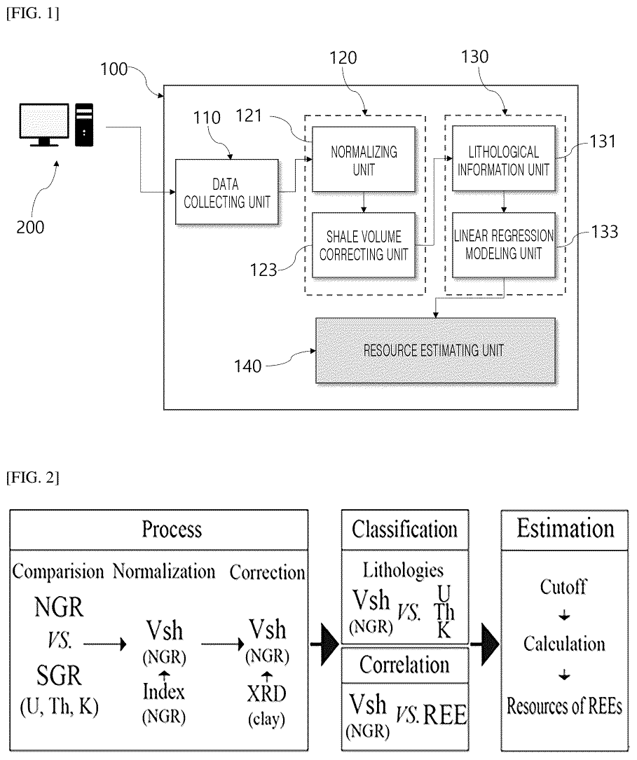

FIG. 1 is a block diagram illustrating a system 100 for estimating rare earth resource quantities in deep-sea sediments using gamma rays according to an exemplary embodiment of the present disclosure.

As illustrated in FIG. 1, the system 100 for estimating rare earth resource quantities in deep-sea sediments using gamma rays according to an exemplary embodiment of the present disclosure may include a data collecting unit 110 configured to collect gamma ray data about deep-sea sediments, a data processing unit 120 configured to normalize and process the gamma ray data collected by the data collecting unit 110 and an estimation modeling unit 130 configured to generate a model for estimating a rare earth lithofacies classification information and the rare earth resource quantities using a linear regression based on the gamma ray data normalized by the data processing unit 120.

More specifically, as illustrated in FIG. 1, the data collecting unit 110 may be configured to measure natural gamma rays emitted from deep-sea stratum via a natural gamma ray (NGR) device installed at a deepwater drilling system. The data collecting unit 110 may also be configured to collect the measured NGR data

The data collection unit 110 as described above may include with a communication device to collect the natural gamma ray data online in connection with the NGR server 200 where the external natural gamma ray data is stored. Alternatively, the natural gamma rays may be collected directly through the data collection unit 110 and be stored.

In other words, the data collecting unit 110 may include a communication device capable of collecting gamma ray data online and a database (DB) that stores and manages the collected data.

The data processing unit 120 may include a normalizing unit 121 configured to normalize the gamma ray data collected by the data collecting unit 110 and a shale volume correcting unit 123 configured to correct shale volume of the gamma ray data using X-ray diffraction (XRD) data.

The normalizing unit 121 may adjust the gamma ray reading values as the gamma ray data using the following [Equation 1]. In addition, the normalizing unit 121 may generate a sum of gamma rays (SGR: Sum of Gamma Rays) using [Equation 2] to normalize (IGR: Index of SGR) and may compare the normalized values.

$$I G R = ( N G {R}_{raw} - 1 ) / ( 30 - 1 ) \qquad [ Equation 1 ]$$

Here, IGR stands for Index of Gamma Ray.

$$SGR [ API ] = 16 * K [ \% ] + 8 * U [ ppm ] + Th [ ppm ] IGR = ( S G R - 26 ) ( 114 - 26 ) \qquad [ Equation 2 ]$$

Here, SGR stands for Sum of Gamma Rays.

As described above, in the system 100 for estimating rare earth resource quantities in deep-sea sediments using gamma rays, it is preferable to normalize the gamma ray data because the source NGR data may be variable depending on equipments and personnels who collect the data.

In addition, as illustrated in FIG. 1, the shale volume correcting unit 123 may correct a shale volume of the gamma ray data by using the X-ray diffraction (XRD) data.

In general, the shale volumes of unconsolidated sediments identified from the gamma ray data tend to be overestimated. Nevertheless, the shale volumes of unconsolidated sediments are not overestimated in the result value of quantitative analysis of the clay through the X-ray diffraction (XRD). Therefore, the gamma ray data requires a modest correction.

In other words, in the unconsolidated sediments, an overestimation of shale volume is shown in the gamma ray data. Therefore, the shale volume needs to be corrected by using the quantitative analysis of X-ray diffraction (XRD).

Thus, according to the system 100 for estimating rare earth resource quantities in deep-sea sediments using gamma rays, the shale volume correcting unit 123 may correct the distributed shale volume of the gamma ray data using the XRD data.

This means that the processed NGR and SGR data are used to estimate the shale volume (Vₛₕ) of the stratum, and if the stratum is not consolidated, the X-ray diffraction (XRD) data is integrated to correct the shale volume estimated by the gamma ray. This correction makes it possible to verify whether the shale volume estimated by the gamma ray is consistent with the actual clay content.

Then, as illustrated in FIG. 1, the estimation modeling unit s130 may generate a model for estimating the rare earth lithofacies classification information and the rare earth resource quantities using a linear regression based on the gamma ray data normalized by the data processing unit 120.

Further, the estimation modeling unit 130 may include a lithofacies information unit 131 configured to generate the rare earth lithofacies classification information to classify clay types by analyzing gamma ray spectrum data, and a linear regression modeling unit 133 configured to generate a linear regression model by clay based on the rare earth lithofacies classification information and the gamma ray data normalized and corrected by the data processing unit 120.

The lithofacies information unit 131 may classify the clay types based on rates of thorium (Th), potassium (K) and uranium (U) of the gamma ray spectrum. In addition, the linear regression modeling unit 133 may generate the linear regression model by clay based on the normalized and corrected data depending on the shale volume.

Here, the rare earth lithofacies classification information is generated by classifying the clay types based on rates of thorium (Th), potassium (K) and uranium (U) resulted from analysis of the gamma ray spectrum data.

In addition, as illustrated in FIG. 1, the system 100 according to an exemplary embodiment of the present disclosure may further include a resource estimating unit 140 configured to estimate and forecast a rare earth content by clay and a total rare earth resource quantity using a least square method according to the model generated by the estimation modeling unit 130.

As described above, the system 100 for estimating rare earth resource quantities in deep-sea sediments using gamma rays according to an exemplary embodiment of the present disclosure provides a system that can estimate presence and potential quantity of rare earth elements in deep-sea sediments using a combination of the source gamma ray data, the shale volume correction, and the linear regression modeling.

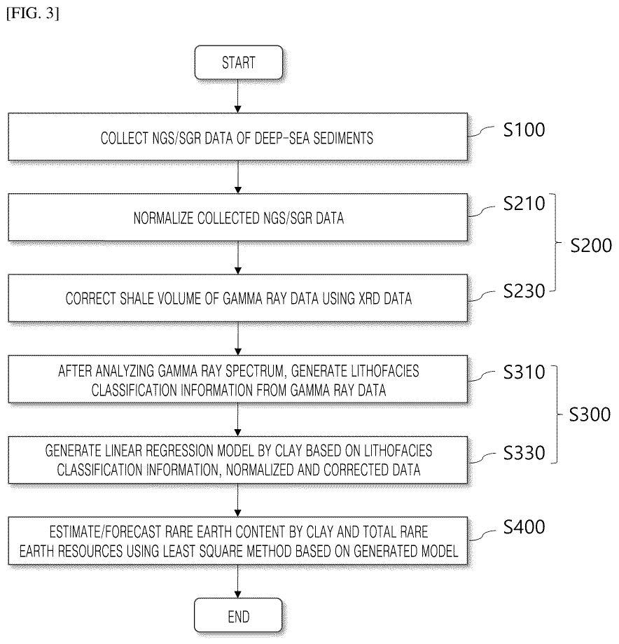

FIG. 2 is a schematic diagram illustrating processes of a method for estimating rare earth resource quantities in deep-sea sediments using gamma rays according to an exemplary embodiment of the present disclosure, and FIG. 3 is a detailed flow diagram of a method for estimating rare earth resource quantities in deep-sea sediments using gamma rays according to an exemplary embodiment of the present disclosure.

As illustrated in FIG. 3, the process of the method for estimating rare earth resource quantities in deep-sea sediments using gamma rays according to an exemplary embodiment of the present disclosure may include data preprocessing to normalize the natural gamma ray data and the sum gamma ray (SGR) data, and to correct the shale volume from the gamma ray data using the XRD data.

Based on gamma-ray spectral data, the lithofacies may be classified according to the distribution of uranium (U), thorium (Th) and potassium (K) contents. Then, a linear regression model may be generated based on this lithofacies information and its relationship with rare earth (REE) measurements. Afterwards, a rare earth content by clay and a total rare earth resource quantity may be estimated based on the generated model.

In particular, as illustrated in FIG. 3, the method for estimating rare earth resource quantities in deep-sea sediments using gamma rays according to an exemplary embodiment of the present disclosure may comprise the steps of: (a) collecting gamma ray data about deep-sea sediments (S100); (b) normalizing and processing the gamma ray data (S200); (c) generating a model for estimating the rare earth resource quantities using a linear regression based on the normalized gamma ray data (S300); and (d) estimating rare earth resource quantity based on the generated model (S400).

Here, the step (a) (S100) may be a step of collecting gamma ray data. The gamma ray data may be collected via online communication from an external system in which natural gamma ray (NGR) data measured from a natural gamma ray (NGR) measuring device installed at a deepwater drilling system.

The step (b) (S200) of normalizing and processing the gamma ray data may include the steps f: (b1) normalizing the gamma ray data collected by the data collecting unit 110 (S210); and (b2) correcting the shale volume of the gamma ray data using X-ray diffraction (XRD) data (S230).

Here, the step (b1) (S210) may include the steps of: normalizing the natural gamma ray (NGR) data collected by the data collecting unit 110 using [Equation 1] as described above; calculating a summed value of the natural gamma ray (NGR) source data using [Equation 2] as described above; and normalizing the calculated value.

The Step (b2) (S230) of correcting the shale volume of the gamma ray data may include the steps of: estimating the shale volume (Vₛₕ) of the stratum using the natural gamma ray (NGR) data and the sum of gamma ray (SGR) data; and correcting the estimated shale volume by integrating the X-ray diffraction (XRD) data when the stratum is not consolidated. This correction makes it possible to verify whether the shale volume estimated by the gamma ray is consistent with the actual clay content.

Such estimating or converting the natural gamma ray (NGR) data to shale volume (Vₛₕ) may be performed in order to convert the NGR and SGR data to a Shale Index, which excludes non-clay components from the clay to see only the percentage of clay, for using an expression to obtain the appropriate shale volume (Vₛₕ) for unconsolidated sediments.

The step (c) (S300) of generating a model for estimating the rare earth resource quantities may be a step to generate a linear regression model by analyzing the relationship between the actual rare earth (REE) measurements and the shale volume and lithofacies classification information.

In particular, the step (c) (S300) may include the steps of: (c1) generating, by the estimation modeling unit 130, a rare earth lithofacies classification information to classify clay types by analyzing gamma ray spectrum data (S310); and (c2) generating, by the estimation modeling unit 130, a linear regression model by clay based on the rare earth lithofacies classification information and the normalized and corrected gamma ray data (S330).

The step (c1) (S310) may involve examining the ratio of thorium (Th), potassium (K), and uranium (U), based on the gamma ray spectrum data, to generate the lithofacies classification information for classify clay types. The step (c2) (S330) may involve generating the linear regression model for each clay of which lithofacies is classified.

That is, the step (c) (S300) may be to determine the most likely clay type (e.g., apatite-rich clay, Fe-Mn-rich clay, or Fe-rich zeolite clay, etc.) based on the sum of gamma ray (SGR) data and the shale volume (Vₛₕ) value, and to generate a linear regression model.

Based on actual rare earth (REE) measurements and shale volume, and based on the lithofacies classification information, the following linear regression model may be generated:
1) Zeolitic clay rich in bioapatite: y=3488.36*x−605.448
2) Fe-Mn-rich zeolitic clay: y=1271.5*x+375.136
3) Iron-rich clay: y=814.688*x+303.721

Here, ‘x’ is the normalized gamma ray reading or Vₛₕ value.

The step (d) (S400) of estimating the rare earth resource quantity may be to estimate the rare earth resource quantity of the deep-sea sediments based on the model generated in the step (c) (S300).

That is, the step (d) (S400) may be to estimate the rare earth resource quantity based on the model generated in step (c) (S300), wherein a model for estimating the total rare earth resource quantity may be applied to express the rare earth resource quantity calculation formula as shown in [Equation 3].

$$Y = 2239.41 * X ( {V}_{s h} N G R ) - 29.8112 ( 800 < X \leq 3500 ) \qquad [ Equation 3 ]$$

Here, ‘Y’ is the estimated rare earth resource quantity, and ‘X’ is values of the the shale volume (Vₛₕ) and the normalized natural gamma ray (NGR) to obtain a comprehensive estimate of the total rare earth resource quantity.

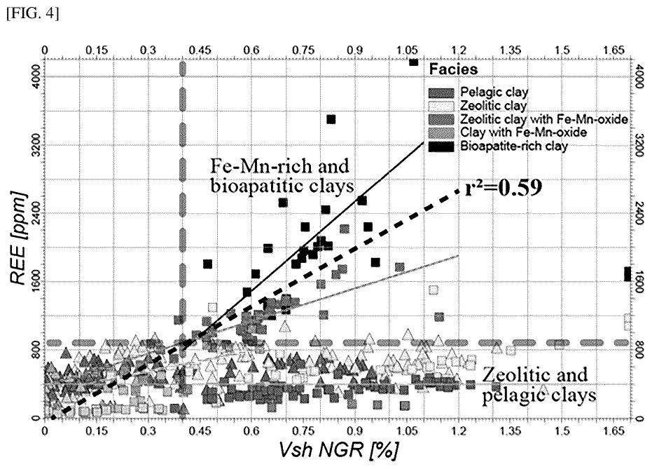

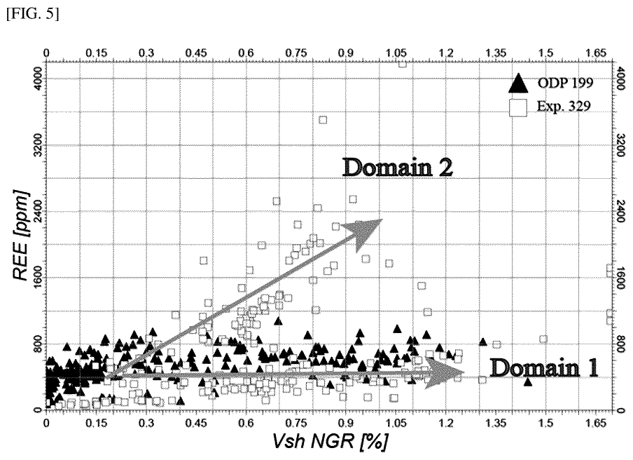

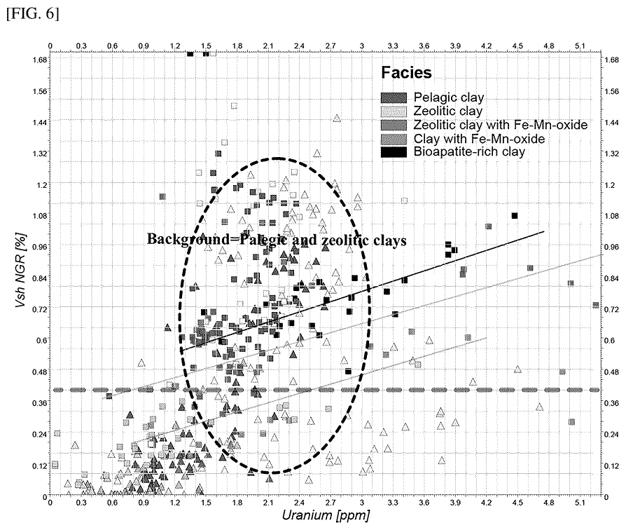

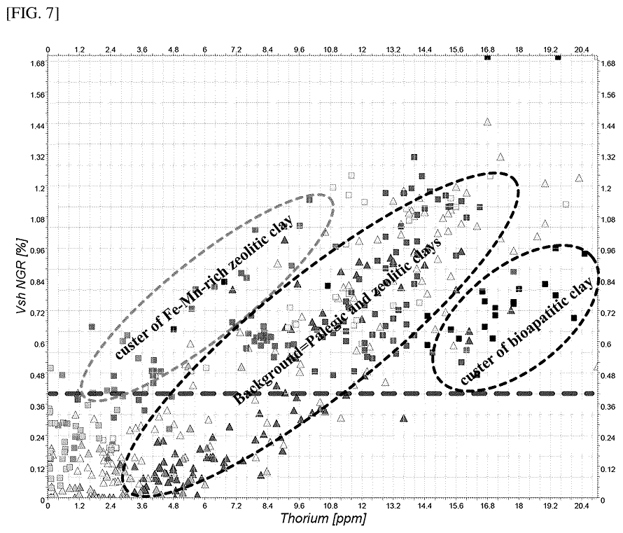

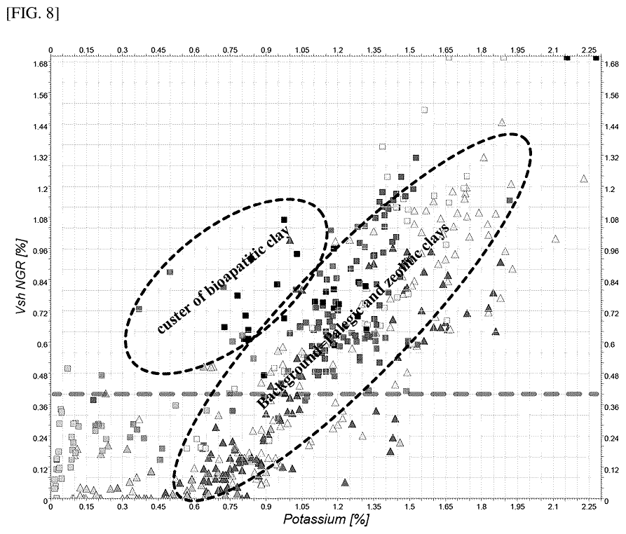

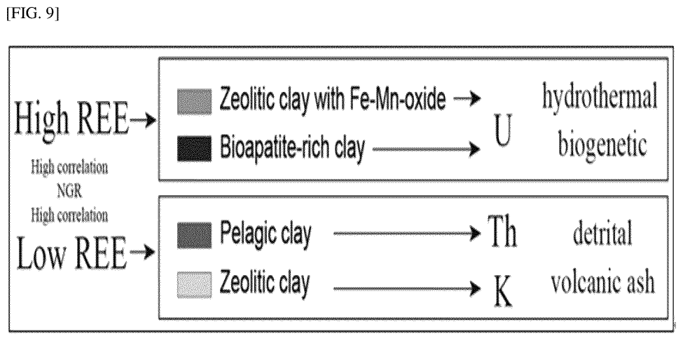

FIG. 4 is a graph showing a result of comparison between rare earth measurements and shale volume (Vₛₕ) of natural gamma ray data for application of a method for estimating rare earth resource quantities in deep-sea sediments using gamma rays according to an exemplary embodiment of the present disclosure, FIG. 5 is a distribution graph showing rare earth measurements in respect to shale volume (Vₛₕ) of natural gamma ray data for forecasting a rare earth lithofacies distribution based on gamma ray data according to a method for estimating rare earth resource quantities in deep-sea sediments using gamma rays according to an exemplary embodiment of the present disclosure, FIGS. 6 through 8 are diagrams showing proportional relationships of bioapatite and Fe-Mn zeolite as well as Th, K lithofacies classification spectrum in uranium applied with a method for estimating rare earth resource quantities in deep-sea sediments using gamma rays according to an exemplary embodiment of the present disclosure, and FIG. 9 is a schematic diagram illustrating a relationship of bioapatite and Fe-Mn zeolite relative to uranium showing high rare earth content.

As illustrated in FIG. 4, the comparison of rare earth (REE) measurements with Vₛₕ values (Vₛₕ NGR [%]) clearly shows that at values above 40% of shale volume (subject to correction with XRD data), there are bioapatite and Fe-Mn zeolite clays with more than 950 ppm of rare earths, and a proportional relationship with rare earths exist.

Furthermore, as illustrated in FIG. 5, the results of Vₛₕ and rare earth measurements are separated into domains in order to analyze the lithofacies classification information that shows a tendency depending on clay classification. Domain 1 represents zeolitic clay and pelagic clay lithofacies. Domain 2 shows no correlation given the wide range of Vₛₕ at different rare earth concentrations (2000 to 10000 ppm).

In addition, Domain 2 represents the iron-containing clay and bioapatite clay lithofacies, which are prominent in the area of Exp.329, and shows relatively high rare earth concentrations and low Vₛₕ (above 900 ppm and below 0.5), which are proportionally related, with bioapatite clay having the highest concentrations.

Furthermore, as illustrated in FIG. 6 through FIG. 8, the gamma ray spectrum data reveals that Vₛₕ NGR, Th, and K form a crust around the background. Thus, bioapatite and Fe-Mn zeolite clay can be classified, where the proportional relationship can be redundantly confirmed through U.

In addition, as illustrated in FIG. 9, in the result of comparison of rare earth (REE) measurements with Vₛₕ shows, the proportional relationships of bioapatite and Fe-Mn zeolite are shown in values having low shale (50%) from high correlation of NGR data. Most of lithofacies below 800 ppm of rare earths exhibit either pelagic clays or Mn-Fe-free zeolites.

In the above, [Equation 3] presents the equation for estimating or evaluating rare earth resource quantity using the linear regression model by the least square method in respect to bioapatite, Fe-Mn zeolite clay with more than 950 ppm of rare earths through these classified lithofacies. The correlation coefficient is 0.768721, and the r2 value is 0.590931975841.

As described above, the system for estimating rare earth resource quantities in deep-sea sediments using gamma rays according to an exemplary embodiment of the present disclosure a harmonious balance of functionality, efficiency, and user-friendliness, and can streamline the estimating process to ensure more consistent results, thus providing an extremely useful system for deep sea explorations and similar applications.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: system for estimating rare earth resource quantity
110: data collecting unit
120: data processing unit
121: normalizing unit
123: shale volume correcting unit
130: estimation modeling unit
131: lithofacies information unit
133: linear regression modeling unit
140: resource estimating unit
200: NGR server

What is claimed is:

1. A system for estimating rare earth resource quantities in deep-sea sediments using gamma rays, the system comprising:
a data collecting unit configured to collect gamma ray data about deep-sea sediments;
a data processing unit configured to normalize and process the gamma ray data collected by the data collecting unit; and
an estimation modeling unit configured to generate a model for estimating a rare earth lithofacies classification information and the rare earth resource quantities using a linear regression based on the gamma ray data normalized by the data processing unit.

2. The system of claim 1,
wherein the gamma ray data includes natural gamma ray (NGR) data and sum of gamma ray (SGR) data.

3. The system of claim 1, wherein the data processing unit includes:
a normalizing unit configured to normalize the gamma ray data collected by the data collecting unit; and
a shale volume correcting unit configured to correct shale volume of the gamma ray data using X-ray diffraction (XRD) data.

4. The system of claim 1, wherein the estimation modeling unit includes:
a lithofacies information unit configured to generate the rare earth lithofacies classification information to classify clay types by analyzing gamma ray spectrum data; and
a linear regression modeling unit configured to generate a linear regression model by clay based on the rare earth lithofacies classification information and the gamma ray data normalized and corrected by the data processing unit.

5. The system of claim 4,
wherein the rare earth lithofacies classification information is generated by classifying the clay types based on rates of thorium (Th), potassium (K) and uranium (U) resulted from analysis of the gamma ray spectrum data.

6. The system of claim 1, further comprising:
a resource estimating unit configured to estimate and forecast a rare earth content by clay and a total rare earth resource quantity using a least square method according to the model generated by the estimation modeling unit.

7. A method for estimating rare earth resource quantities in deep-sea sediments using gamma rays, the method comprising the following steps of:
(a) collecting, by a data collecting unit, gamma ray data about deep-sea sediments;
(b) normalizing and processing, by a data processing unit, the gamma ray data collected by the data collecting unit; and
(c) generating, by an estimation modeling unit, a model for estimating the rare earth resource quantities using a linear regression based on the gamma ray data normalized by the data processing unit.

8. The method of claim 7, wherein the step (a) includes a step of:
collecting, by the data collecting unit, natural gamma ray (NGR) data and sum of gamma ray (SGR) data about the deep-sea sediments.

9. The method of claim 7, wherein the step (b) includes the following steps of:
(b1) normalizing, by the data processing unit, the gamma ray data collected by the data collecting unit; and
(b2) correcting, by the data processing unit, shale volume of the gamma ray data using X-ray diffraction (XRD) data.

10. The method of claim 7, wherein the step (c) includes the following steps of:
(c1) generating, by the estimation modeling unit, a rare earth lithofacies classification information to classify clay types by analyzing gamma ray spectrum data; and
(c2) generating, by the estimation modeling unit, a linear regression model by clay based on the rare earth lithofacies classification information and the gamma ray data normalized and corrected by the data processing unit.

11. The method of claim 10,
wherein the rare earth lithofacies classification information is generated by classifying the clay types based on rates of thorium (Th), potassium (K) and uranium (U) resulted from analysis of the gamma ray spectrum data.

12. The method of claim 7, further comprising a step of:
estimating and forecasting, by a resource estimating unit, a rare earth content by clay and a total rare earth resource quantity using a least square method according to the model generated by the estimation modeling unit.
